(19) United States
(12) Patent Application Publication
(10) Pub. No.: US 2017/0048340 A1
(43) Pub. Date: Feb. 16, 2017

(54) COLLEGE READINESS PREDICTOR AND SELECTION SERVICE USING PROFILE MANAGER AND TRANSLATION VALIDATION

(71) Applicant: SkyNexus Technologies Inc., Irvine, CA (US)

(72) Inventors: Christine Zhang, Irvine, CA (US); Hang Deng, Irvine, CA (US); Zhuo Feng, Irvine, CA (US)

(21) Appl. No.: 15/235,508

(22) Filed: Aug. 12, 2016

Related U.S. Application Data
(60) Provisional application No. 62/204,853, filed on Aug. 13, 2015.

(51) Int. Cl. H04L 29/08; G06F 17/28

(52) U.S. Cl. CPC H04L 67/22; G06F 17/2827; G06F 17/2854; H04L 67/306

(57) ABSTRACT

Systems and methods for managing profiles and performing translations, validating translations, and managing student profiles are disclosed. An exemplary method includes receiving a registration request, providing a registration interface to a user device, receiving an expertise area selection and a user identifier from the user device, converting the expertise area selection from a base language to a target language, sorting users by expertise area into a list, and transmitting the list in the target language to a target user. A translation method includes receiving a sentence in a base language, accessing a translation system, generating and comparing a plurality of translations in a target language, and returning a satisfactory translation. Another exemplary method includes collecting student identity and ranking data, determining an athletic and an academic requirement for a plurality of schools, collecting updated ranking data, and plotting the ranking and the updated ranking data on a college-sports combinations graph.

### PRIORITY CLAIM AND CROSS-REFERENCE TO RELATED APPLICATIONS

The present application claims priority to and the benefit of U.S. Provisional Patent Application Ser. No. 62/204,853, filed Aug. 13, 2015, the entire contents of which is hereby incorporated by reference herein.

### BACKGROUND

Millions of high school students apply to college each year, and the selection process has become extremely competitive for top schools and scholarships. Additionally, the college application process is an extensive process that is time sensitive. As a result, the application process is often stressful and time consuming for applicants and their families. Even before the application process starts, a student begins preparing for college several years in advance. In some instances, the college preparation process could start in elementary school. The sheer amount of time required for the preparation and application process can be overwhelming. This is especially true for families that have non-native speaking parents because it is often difficult for the parents to fully participate in the process with their children.

Despite many advanced translation services and software, there are well documented instances of translation error. Many translation services often fail to accurately translate long strings of text and technical writing. Due to these errors in translated website text, many non-native speaking parents may find it difficult to help their children prepare and plan for college.

Additionally, with the ever continuing increases in college tuition, students are tasked with finding scholarships and financial aid for schools. In some cases, these scholarships may be athletic scholarships. However, few students or parents are aware of what schools the student is best positioned to receive scholarship offers from.

These hurdles can make it difficult for parents to assist their children in applying for and selecting colleges. This is also true for non-native speaking parents who may find it difficult to help assist their children in becoming more prepared for college, getting assistance in classes, etc.

### SUMMARY

The present disclosure provides a system and method that manages profiles. In another example embodiment, a system and method is provided that validates translations. In yet another example embodiment, a system and method is provided that manages, plans, and evaluates student profiles. In another example embodiment, a system and method is provided that predicts college athlete readiness. Some example embodiments may be a modified online platform that allows for culturally integrated engagement. Additionally, other example embodiments may be an academic management system.

The present disclosure provides new and innovative systems, methods, and apparatuses to predict college readiness and provide tutor selection services using translation validation. The example software or website is configured to predict the best colleges to apply to based on grades, student activities, sports, and other factors. The software tracks the student's progress and provides feedback and recommendation to meet specific goals. The software also enables non-native speaking users, such as parents, to help screen and select tutors for their children using the tutor selection service that is translated to the appropriate language.

In an exemplary aspect of the present disclosure, a method to manage profiles (e.g., a tutor profile) and validate profile translations includes receiving a registration request (e.g., a tutor registration request) from a user device operated by a user (e.g., a tutor), providing a registration interface to the user device for display to the user; receiving at least one expertise area selection and a tutor identifier in a base language from the user device, translating the at least one expertise area selection from the base language to a target language from a translation database, sorting the users by expertise area selection and credentials into a list, and displaying the list of users (e.g., tutors) in the target language to a target user on the user device.

In accordance with another exemplary aspect of the present disclosure, which may be used in combination with the preceding aspect, the method may also include generating an expertise area selection. The expertise area selection is generated by receiving, via the interface on the user device, text from the user in a base language, generating a translation in the target language, and entering the translation as the expertise area selection. The translation may be generated using a translation service and the translation may be entered by an administrative user.

In accordance with another exemplary aspect of the present disclosure, which may be used in combination with the preceding aspect, the method may also include generating an expertise area selection. The expertise are selection is generated by receiving a sentence string from a user (e.g., tutor) in the base language, accessing a translation system, generating a plurality of translations of the sentence string in the target language, comparing the plurality of translations in the target language to confirm a satisfactory translation, and saving the satisfactory translation to the translation database.

In accordance with another exemplary aspect of the present disclosure, which may be used in combination with the preceding aspect, the method also includes adjusting the translation for unsatisfactory translations.

In accordance with another exemplary aspect of the present disclosure, a method of validating translation information includes receiving, via an interface on a user device, at least one sentence string from a user in a base language, accessing a translation system, generating a plurality of translations of the at least one sentence string in a target language, comparing the plurality of translations in the target language to confirm a satisfactory translation, and returning the satisfactory translation to the user.

In accordance with another exemplary aspect of the present disclosure, which may be used in combination with the preceding aspect, a method to manage student profiles includes receiving profile information from a user device operated by a user, inviting the user to input at least one goal, evaluating profile information and the at least one goal to create a comparison report in response to the profile information and the at least one goal, generate a game plan to achieve the at least one goal, and creating at least one recommendation in response to the game plan.

In accordance with another exemplary aspect of the present disclosure, which may be used in combination with the preceding aspect, the method also includes tracking the user's progress in relation to the at least one goal and the game plan, updating the profile information in response to the user's progress, and generating a report in response to the user's progress.

In accordance with another exemplary aspect of the present disclosure, which may be used in combination with the preceding aspect, a method to predict college readiness includes collecting student identity data and a first ranking data, wherein the ranking data includes athletic data and academic data, determining an athletic requirement and an academic requirement from a plurality of schools, collecting at least one updated ranking data, and plotting the first ranking data and the at least one updated ranking data on a college-sport combinations graph, wherein the college-sport combinations graph includes academic data plotted along an X coordinate and athletic data plotted along a Y coordinate.

In accordance with another exemplary aspect of the present disclosure, which may be used in combination with the preceding aspect, a tutor management system includes a network interface, a user device having a processor, and a memory coupled to the processor. The memory comprises instructions for execution on the processor configured for executing steps of receiving a tutor registration request from a user device operated by a tutor user, providing a registration interface to the user device for display to the tutor user, receiving at least one expertise area selection and a tutor identifier in a base language from the user device, translating the at least one expertise area selection from the base language to a target language from a translation database, sorting the tutor users by expertise area selection and credentials into a list, and displaying the list of tutor users in the target language to a target user on the user device.

Additional features and advantages of the disclosed system, method, and apparatus are described in, and will be apparent from, the following Detailed Description and the Figures.

### BRIEF DESCRIPTION OF THE FIGURES

FIG. 1 is a block diagram of an example network communicating system, according to an example embodiment of the present disclosure.

FIG. 2A is a detailed block diagram showing an example of a profile manager and translator, according to an example embodiment of the present disclosure.

FIG. 2B is a detailed block diagram showing an example of a student profile manager and planner, according to an example embodiment of the present disclosure.

FIG. 2C is a detailed block diagram showing an example of a college readiness predictor, according to an example embodiment of the present disclosure.

FIGS. 3A and 3B illustrate a flow diagram showing example procedures to manage profiles, according to an example embodiment of the present disclosure.

FIG. 3C illustrates a flow diagram showing an example procedure to validate translations, according to an example embodiment of the present disclosure.

FIG. 4 illustrates a flow diagram showing example procedure to manage student profiles, according to an example embodiment of the present disclosure.

FIG. 5 illustrates a flow diagram showing example procedures to predict college readiness, according to an example embodiment of the present disclosure.

FIG. 6 is a table that illustrates a website used to predict college readiness, according to an example embodiment of the present disclosure.

### DETAILED DESCRIPTION

The present disclosure relates in general to a method, apparatus, and system to predict college readiness, manage profiles, provide selection services (e.g., a tutor selection service), and validate translations.

Briefly, in an example embodiment, a system and method is provided that manages profiles. In another example embodiment, a system and method is provided that validates translations. In yet another example embodiment, a system and method is provided that manages, plans, and evaluates student profiles. In another example embodiment, a system and method is provided that predicts college athlete readiness. These systems may include a network interface, a user device having a processor, and a memory coupled to the processor. The memory may comprise instructions for execution on the processor configured for executing steps related to managing profiles, validating translations, planning and evaluating student profiles, and/or predicting college readiness.

Additionally, throughout the disclosure, reference is made to user devices, which can include any cellphone, smartphone, personal digital assistant (“PDA”), mobile device, tablet computer, computer, laptop, server, processor, console, gaming system, multimedia receiver, or any other computing device. While this disclosure refers to connection between a single user device and a server, the example method, apparatus, and system disclosed herein can be applied to multiple client devices connected to one or more servers.

Examples in this disclosure describe user devices and servers performing evaluation and college recommendation processes. However, the example method, apparatus, and system disclosed herein can be applied to any type of evaluation and recommendation process between a server and a user device including, but not limited to, home purchasing or neighborhood planning, job searching, vacation planning, etc.

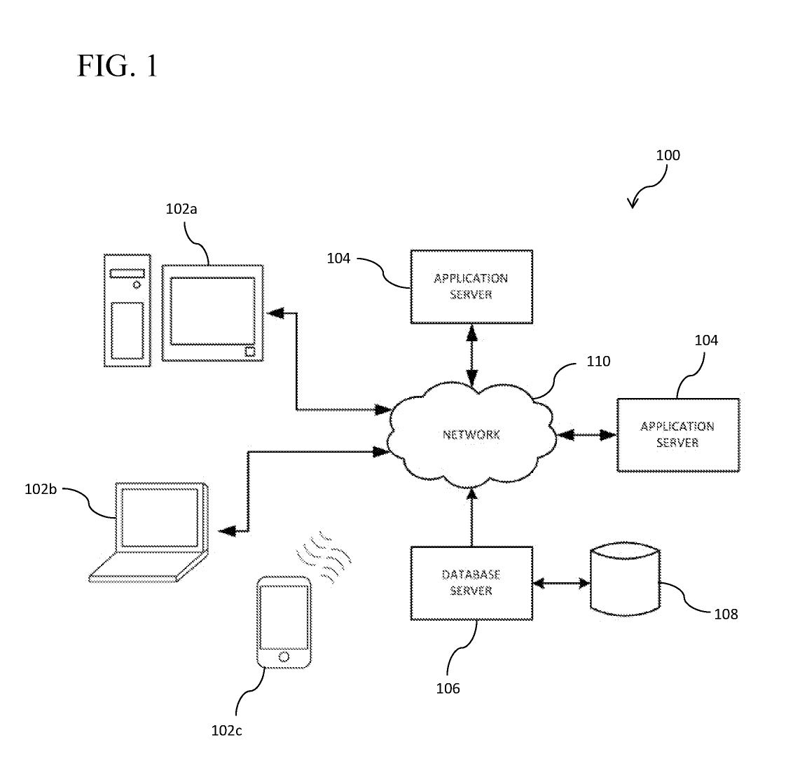

The present system may be readily realized in a network communications system. A diagram of an example network communications system 100 is illustrated in FIG. 1. The illustrated system 100 includes one or more user devices 102, one or more application servers 104, and one or more database servers 106 connected to one or more databases 108. Each user device 102 may include a desktop computer (102a), a laptop computer (102b), or a smartphone (102c). The user device 102 may also include, for example, a server, a tablet, a workstation, a PDA, etc. The user device 102 may include an interface for receiving or otherwise communication with the one or more databases 108 (or storage device). Each of these devices may communicate with each other via a connection to one or more communication channels in a network 110. The network 110 can include, for example the Internet or some other data network, including, but not limited to, any suitable wide area network or local area network. It should be appreciated that any of the devices described herein may be directly connected to each other and/or connected through the network 110. The network 110 may also support wireless communication with wireless client devices 102.

The user devices 102 access data, services, media content, and any other type of information located on the servers 104 and 106. The user devices 102 may include any type of operating system and perform any function capable of being performed by a processor. For example, a user may access and transmit the relevant data via a web browser displayed on the user device 102. In another example embodiment, the relevant data may be transmitted via a cell phone or tablet application or any other general display platform or the like. The web browser is adapted for accessing the application server 104. For instance, the user devices 102 may access, read, write information, and/or host a website that enables users to select a tutor based on subject specific qualifications. In an example embodiment, the servers 104 and 106 may host a website that enables tutors to input their skills in a target language, which can be translated into the base language for the users. For each translation that takes place through the website, the database servers 106 store the translations in a database to build a library of verified translations.

Typically, servers 104 and 106 process one or more of a plurality of files, programs, data structures, databases, and/or web pages in one or more memories for use by the user devices 102, and/or other servers 104 and 106. The application servers 104 may provide services accessible to the user devices 102 while the database servers 106 provide a framework for the user devices 102 to access data stored in the database 108. The servers 104 and 106 may be configured according to their particular operating system, applications, memory, hardware, etc., and may provide various options for managing the execution of the programs and applications, as well as various administrative tasks. A server 104, 106 may interact via one or more networks with one or more other servers 104 and 106, which may be operated independently.

The example servers 104 and 106 provide data and services to the user devices 102. The servers 104 and 106 may be managed by one or more service providers, which control the information and types of services offered. These services providers also determine qualifications as to which user devices 102 are authorized to access the servers 104 and 106. The servers 104 and 106 can provide, for example, banking services, online retain services, social media content, multimedia services, government services, educational services, etc.

While the servers 104 and 106 are shown as individual entities, each server 104 and 106 may be partitioned or distributed within a network. For instance, each server 104 and 106 may be implemented within a cloud-computing network with different processes and data stored at different servers or processors. Additionally, multiple servers or processors located at different geographic locations may be grouped together as server 104 and 106. In this instance, network routers determine which user device 102 connects to which processor within the application server 104.

### Profile Management and Translation

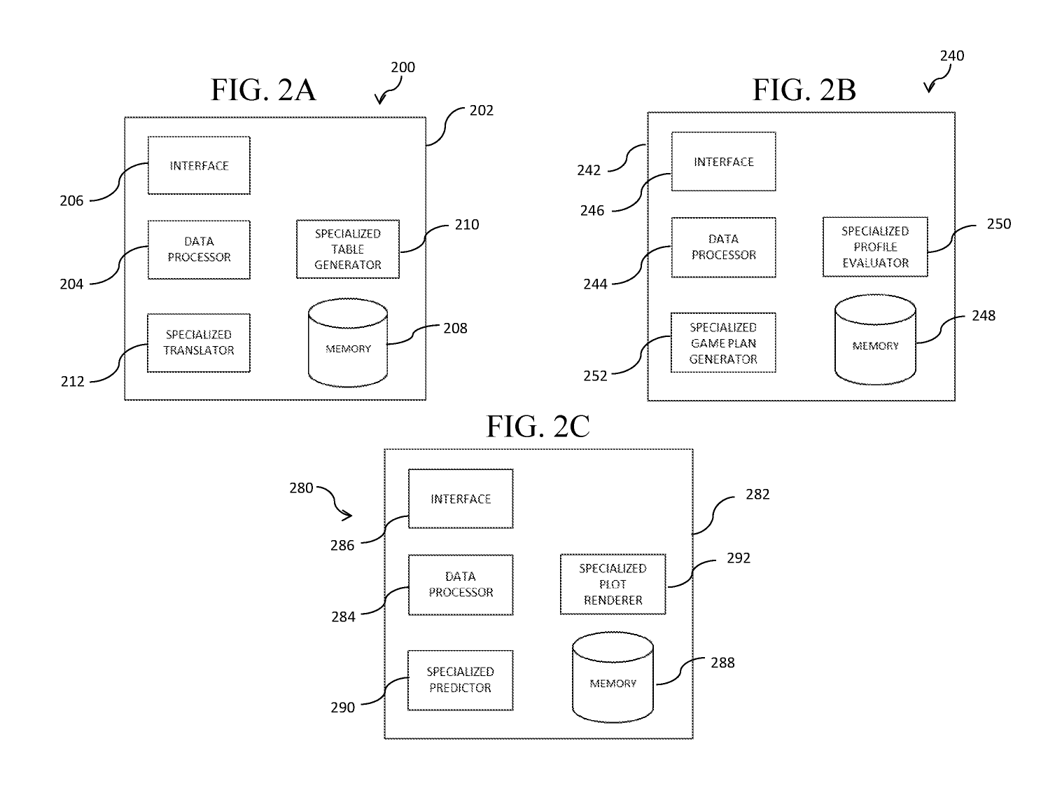

A detailed block diagram of an example profile manager and translator 200 is illustrated in FIG. 2A. The profile manager may be used to manage profiles. In this example, the profile manager and translator 200 includes a main unit 202, which preferably includes at least one data processors 204 and an interface 206. The data processors 204 may be communicatively coupled by an address/data bus to at least one memory device 208. The processor 204 may be any suitable processor, such as a microprocessor from the Intel PENTIUM®, CORE™, or XEON®; Advanced Micro Devices (AMD) FX, A, ATHLON®, or OPTERON®; Broadcom; NVidia; Qualcomm; IBM; Marvell; Sun; Cyrix; Via; Freescale; Apple, or Texas Instruments' family of microprocessors. The memory 208 preferably includes volatile memory and non-volatile memory. Preferably, the memory 208 stores a software program that interacts with the other devices in the system 100, as described below. This program may be executed by the data processor 204 in any suitable manner. The memory 208 may also store digital data indicative of documents, files, programs, web pages, etc. retrieved from the profile manager and translator 200.

The example memory device 208 stores software instructions, webpages, user interface features, permissions, protocols, profile information, and/or translations. It will be appreciated that many other data fields and records may be stored in the memory device 208 to facilitate implementation of the methods and apparatus disclosed herein. In addition, it will be appreciated that any type of suitable data structure (e.g., a flat file data structure, a relational database, a tree data structure, a non-relational database, etc.) may be used to facilitate implementation of the methods and apparatus disclosed herein.

In an example embodiment, the profile manager and translator 200 may also include a specialized table generator 210. The specialized table generator 210 creates correlation tables of tutor expertise areas in a plurality of target languages. For example, each expertise area, target language, and/or translation may be assigned a variable and compared in a correlation table. The correlation tables advantageously allow the profile manager and translator 200 to provide tutor profile information to foreign speaking users. For example, if an English-speaking student has Chinese-speaking parents, the parents may find it difficult to search for and select a tutor that speaks and advertises in English.

The profile manager and translator 200 may also include a specialized translator 212. The specialized translator 212 receives information by a selection or input by the user through the interface 206 of the main unit 202 in a base language. Then, the specialized translator formats the user input and obtains several sample translations in a target language from a plurality of translation services. For example, the specialized translator 212 may format the user input so that it can be sent and properly recognized by services such as google translate, Dragon®, Babylon, etc. After the plurality of translations are received, the specialized translator 212 formats the received translations so that they can be compared. The specialized translator 212 then verifies that a satisfactory translation has taken place (i.e., all the sample translations in the target language match). If the translation is unsatisfactory, the specialized translator 212 sends instruction to modify the translation, and the modified translation is stored in a translation database for future users. This advantageously allows the translation database to build an extensive translation library for tutor specific language.

In an example embodiment, the specialized translator 212 may receive information from a user input through the interface 206 and may send a translation request to an administrative user. The translation request may include an e-mail notification to the administrative user and may include several translations of the user input from various translation sources (e.g., google translate, etc.). The translation request may also include several web-links to various translation services in the e-mail notification to the administrative user. The administrative user may then confirm a proper translation, which can be stored in the translation database by the specialized translator 212, and updated in the user's profile.

In an example embodiment, a system is provided that manages profiles such as tutor profiles, professional profiles, real estate profiles, restaurant profiles, or the like. For illustrative purposes, the profile management system is described using tutor profiles as an example, however, the profile management system can be used to manage and sort a wide variety of profile information. The management system includes a network interface, a user device having a processor, and a memory coupled to the processor. The memory comprises instructions for execution on the processor configured for executing steps of receiving a tutor registration request from a user device operated by a tutor user. Additionally, the instructions provide a registration interface to the user device for display to the tutor user. The user may select at least one expertise area selection and input a tutor identifier, such as his or her name, into the registration interface. The selections and inputs may be entered in a base language, such as English, from the user device. Then, the processor translates or converts the at least one expertise area selection from the base language to a target language, such as Chinese from a translation database. An expertise area selection may be a general subject that a user specializes in such as Math, Science, Writing, etc. Additionally, the expertise area selection may be more specific and include subject specific selections such as Calculus, Thermal Physics, Spanish, Biochemistry, etc. Furthermore, in other example embodiments, the expertise area selection may be the type of cuisine a restaurant serves for a restaurant profile manager; the price, location, and/or square footage of a house on a real estate profile manager; work experience and/or technical background for a professional profile manager; or any other sortable profile. In another example embodiment, the expertise are selection may include a brief description such as “multi-variable calculus and derivatives”, “geometry proof solving”, “advanced Spanish reading and writing”, etc. If a selection is not available, then a validated translation must be created. The validated translation may be created by comparing a plurality of translations provided from a translation service. If the plurality of translations match, then the translation is validated. However, if the plurality of translations do not match, then manual adjustment to the translation may be made and then saved in the translation database. In another example embodiment, the translation is validated by an administrative user that selects the best translation based on a plurality of translations generated from a translation request. Once the expertise area selection is completed, the processor sorts the tutor users by expertise area selection and credentials into a list. The tutor users may also be sorted by other factors include geography, race, age, gender, cost, past reviews, etc. Then processor also displays the list of tutor users in the target language to a target user on the user device. This system allows a Chinese (target language) speaking/reading parent to help select a tutor for their English (base language) speaking children.

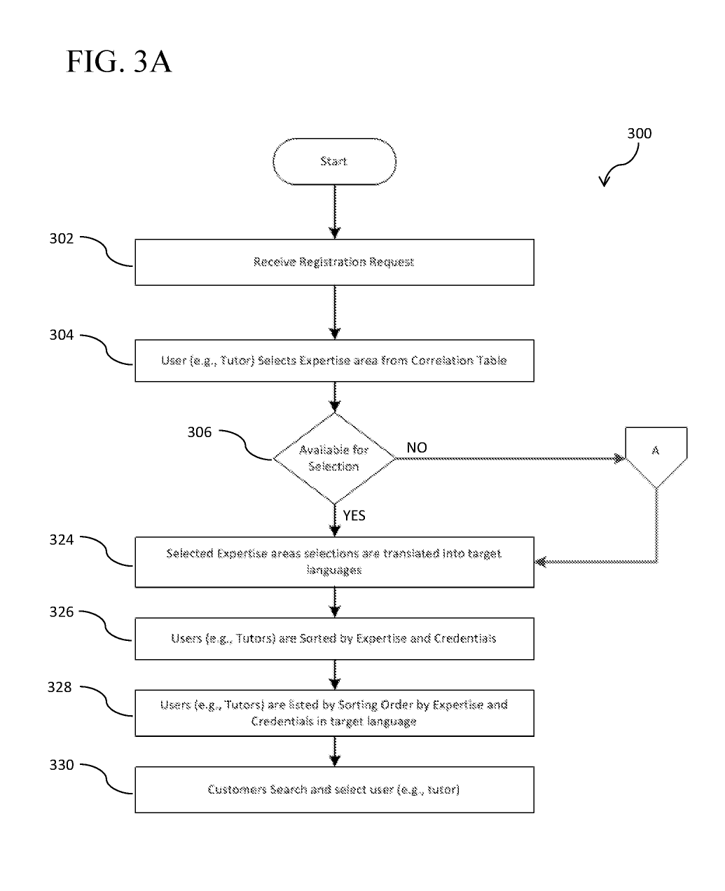

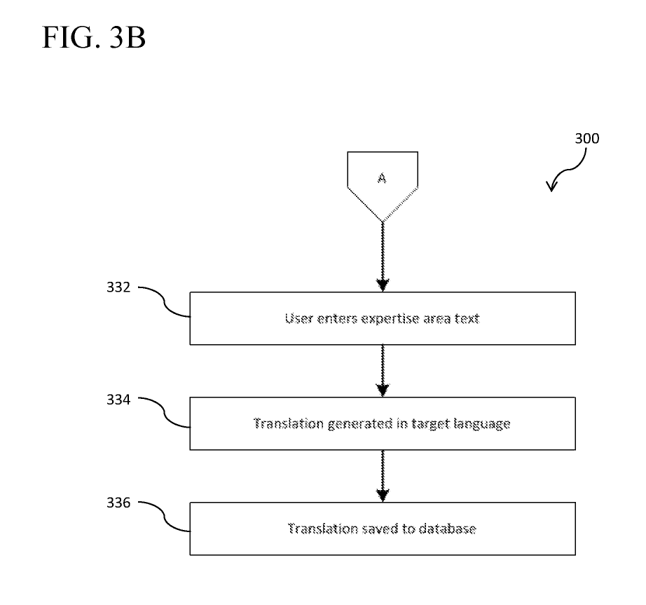

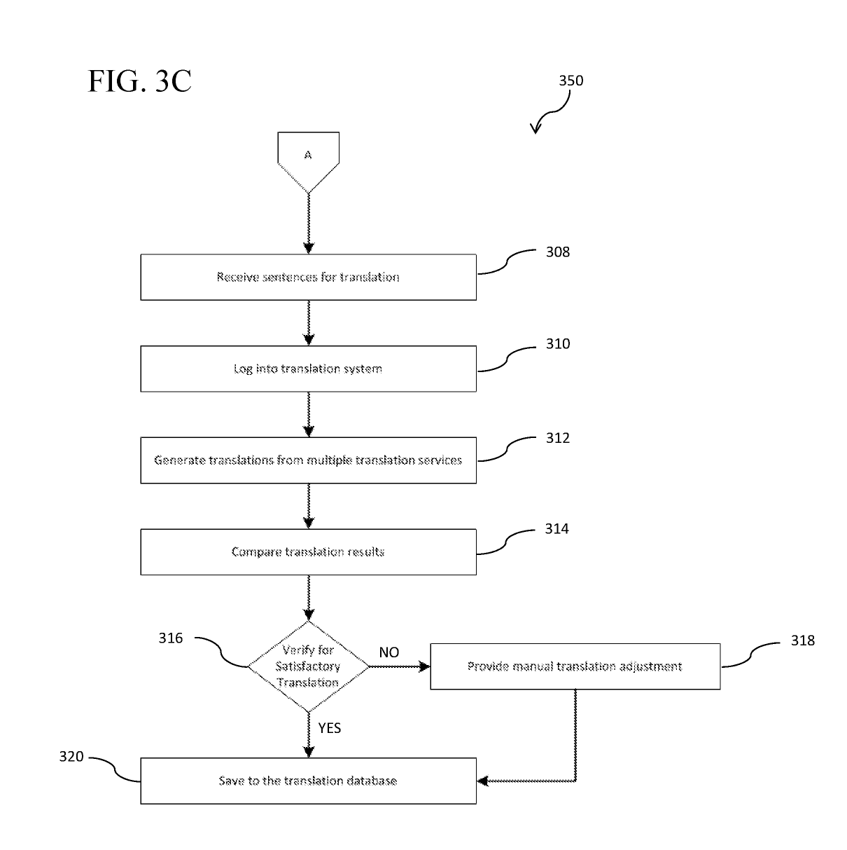

FIGS. 3A and 3B are a flow diagram showing example procedure 300 to manage profiles and perform translations, according to an example embodiment of the present disclosure. In another example embodiment, example procedure 300 may use a profile translation validation (procedure 350) as shown in FIG. 3C. Although the procedure 300 is described with reference to the flow diagram illustrated in FIGS. 3A and 3B, it will be appreciated that many other methods of performing the acts associated with the procedure 300 may be used. For example, the order of many of the blocks may be changed, certain blocks may be combined with other blocks, and many of the blocks described are optional.

The example procedure 300 operates on, for example, the user device 102 of FIG. 1. The procedure 300 begins when the user device 102 receives a tutor registration request from a user (block 302). The registration request can include a website address or IP address that is routed by the network 110 to the appropriate server 104. For example, a user (e.g., a tutor) may access the tutor registration website displayed the user device 102.

Once the registration request is received, the tutor selects his or her expertise area from the proper correlation table (block 304) if the expertise area is available for selection (block 306). If the correlation table does not include the user's (e.g., tutor's) expertise area, then the user may enter expertise area text in the designated field on the interface of the user device 102 (block 332). Then, a translation is generated in a target language (block 334). For example, a translation may be obtained from a translation database or a translation service such as Google Translate. Additionally, an e-mail may be sent to the user with a web-link that includes several methods of translation that can be selected by the user. In another example embodiment, after the user enters expertise area text, a translation is generated from a translation request. The translation request may result in a plurality of translations being obtained from various translation services. Additionally, the translation request may send an e-mail notification to an administrative user with the plurality of translations. The administrative user may then select the best translation. Then, the selected translation is saved to the translation database so that it will be available in the correlation table for future users to select (block 336).

In another example embodiment, the translation validation process described in FIG. 3C may be used. For example, if the correlation table does not include the user's (e.g., tutor's) expertise area, then the user device 102 receives expertise area description sentences for translation (block 308). The user device 102 accesses the translation system (block 310) and then the translation system generates multiple translations from various translation services (block 312). For example, the translation system or specialized translator 212 formats the description sentences to ensure that they can be properly received by a plurality of translation services. Once the description sentences are formatted, the translation system sends the sentences to a plurality of translation services such as google translate, Dragon®, Babylon, etc. The translation system formats the plurality of translations so that each translation can be interpreted by the system. Then, the translation results are compared against the results stored in the database and to each other to determine if the translation is satisfactory (block 314). If the translation results do not match, the translation will be manually adjusted (block 318) to achieve a satisfactory translation. Once a satisfactory translation is achieved, the translation is saved to the translation database (block 320). Then, the user's (e.g., tutor) selected expertise area selections are translated into a target language (block 324). For example, if the tutor enters information in English, but the site is being accessed by a parent that speaks/reads in Chinese, then the expertise area information is translated into Chinese so that it can be reviewed by the Chinese parent. Once the tutor's information is included in the database, each of the tutor's are sorted by expertise and credentials (block 326). Then, the system lists the sorted order of the tutors in the target language (block 328) and customers search for and select a tutor from the list (block 330). Additionally, the search and selection may be done in the target language (e.g., Chinese). For example, a user (e.g., a customer) may search for tutors by searching for specific expertise areas in the target language. Additionally, the translation system may generate a sorted list of tutors that is displayed to the users (e.g., customers) via the user device. In an example embodiment, the list is displayed in the target language. Then, the user (e.g., a customer) may select a tutor from the sorted list of tutors in the target language based on the customer's search criteria. In another example embodiment, the user (e.g., customer) may also search and select in the base language.

### Translation Verification

In an example embodiment, a system is provided that provides translation verification. The translation verification system includes a network interface, a user device having a processor, and a memory coupled to the processor. The memory comprises instructions for execution on the processor configured for executing steps of receiving a tutor registration request from a user device operated by a tutor user.

FIG. 3C is a flow diagram shows an example procedure 350 to validate and/or verify translations, according to an example embodiment of the present disclosure. Although the procedure 350 is described with reference to the flow diagram illustrated in FIG. 3C, it will be appreciated that many other methods of performing the acts associated with the procedure 350 may be used. For example, the order of many of the blocks may be changed, certain blocks may be combined with other blocks, and many of the blocks described are optional.

The example procedure 350 operates on, for example, the user device 102 of FIG. 1. The procedure 350 begins when the user device 102 receives sentences for translation (block 308). For example, the sentences may be a paragraph describing a user, such as a profile “bio” section. The user device 102 accesses the translation system (block 310) and then the translation system generates multiple translations from various translation services (block 312). For example, the translation system or specialized translator 212 formats the description sentences to ensure that they can be properly received by a plurality of translation services. Once the description sentences are formatted, the translation system sends the sentences to a plurality of translation services such as google translate, Dragon®, Babylon, etc. The translation system formats the plurality of translations so that each translation can be interpreted by the system. Then, the translation results are automatically compared against the results stored in the database and to each other to determine if the translation is satisfactory (block 314). For example, the translation results may be automatically compared using a regression analysis that determines the best translation from the plurality of translations. In an example embodiment, the translation system may provide a rating for each translation, so that the top translations can reviewed and compared. If the translation results do not match, the translation will be manually adjusted (block 318) to achieve a satisfactory translation. Once a satisfactory translation is achieved, the translation may be saved to a translation database (block 320). The satisfactory translation may be displayed on the user device. In an example embodiment, the satisfactory translation is displayed in the target language on the user device for the user. This example procedure advantageously allows large amounts of text to be translated accurately and validated for the user whereas current translation services often contain errors for translation requests that include long strings of text or several sentences of text.

### Profile Manager, Evaluator, and Planner

A detailed block diagram of an example student profile manager and planner 240 is illustrated in FIG. 2B. In this example, the student profile manager and planner 240 includes a main unit 242, which preferably includes one or more data processors 244 and an interface 246. The data processors 244 may be communicatively coupled by an address/data bus to at least one memory device 248. The processor 244 may be any suitable processor, such as a microprocessor from the Intel PENTIUM®, CORE™, or XEON®, Advanced Micro Devices (AMD) FX, A, ATHLON®, or OPTERON®, Broadcom; NVidia; Qualcomm; IBM; Marvell; Sun; Cyrix; Via; Freescale; Apple, or Texas Instruments' family of microprocessors. The memory 248 preferably includes volatile memory and non-volatile memory. Preferably, the memory 248 stores a software program that interacts with the other devices in the system 100, as described below. This program may be executed by the data processor 244 in any suitable manner. The memory 248 may also store digital data indicative of documents, files, programs, web pages, etc. retrieved from the student profile manager and planner 240.

The example memory device 248 stores software instructions, webpages, user interface features, permissions, protocols, profile information, and/or goal recommendations. It will be appreciated that many other data fields and records may be stored in the memory device 208 to facilitate implementation of the methods and apparatus disclosed herein. In addition, it will be appreciated that any type of suitable data structure (e.g., a flat file data structure, a relational database, a tree data structure, a non-relation database, etc.) may be used to facilitate implementation of the methods and apparatus disclosed herein.

In an example embodiment, the student profile manager and planner 240 may also include a specialized profile evaluator 250. The specialized profile evaluator 250 evaluates goals input by the user against the user's profile information. The user may specify both short term and long-term goals, which may be evaluated against the students profile information. In an example embodiment, the goals are interactive with a calendar functionality of the profile manager and planner 240. For example, the user may input a short-term goal such as improving his or her math grade from a C+ to an A− by the end of the second semester of school, making the varsity basketball team, winning the high-school bridge competition, or improving their mile-run time to 6 minutes within the next 5 months. It should be noted that the user may specify a plurality of goals that the system can evaluate simultaneously. For example, the user may have ongoing short and long term goals related to school, sports, and other activities. In an example embodiment, the user's profile information may include personal information, academic records, extracurricular activities, sports records, and other character information. The personal information includes information related to the user's age, school, graduation class, etc. The academic record information may include course selections, GPA, standardized test results, as well as honors and awards. Furthermore, the personal profile information includes extracurricular activities such as volunteer work, leadership, service, and involvement in other clubs and organizations. The sports records may include sport performance, tournament information, awards, etc. The sports records may include video clips or stats that can be imported from other databases such as the school's website or other record reporting entities. Lastly, the character information may include personal qualities, recommendations, and essay samples. The information that is not graded or rated on a standard scale like GPA may be provided a rating of 1-10 by a rating system specific to the student profile manager and planner 240.

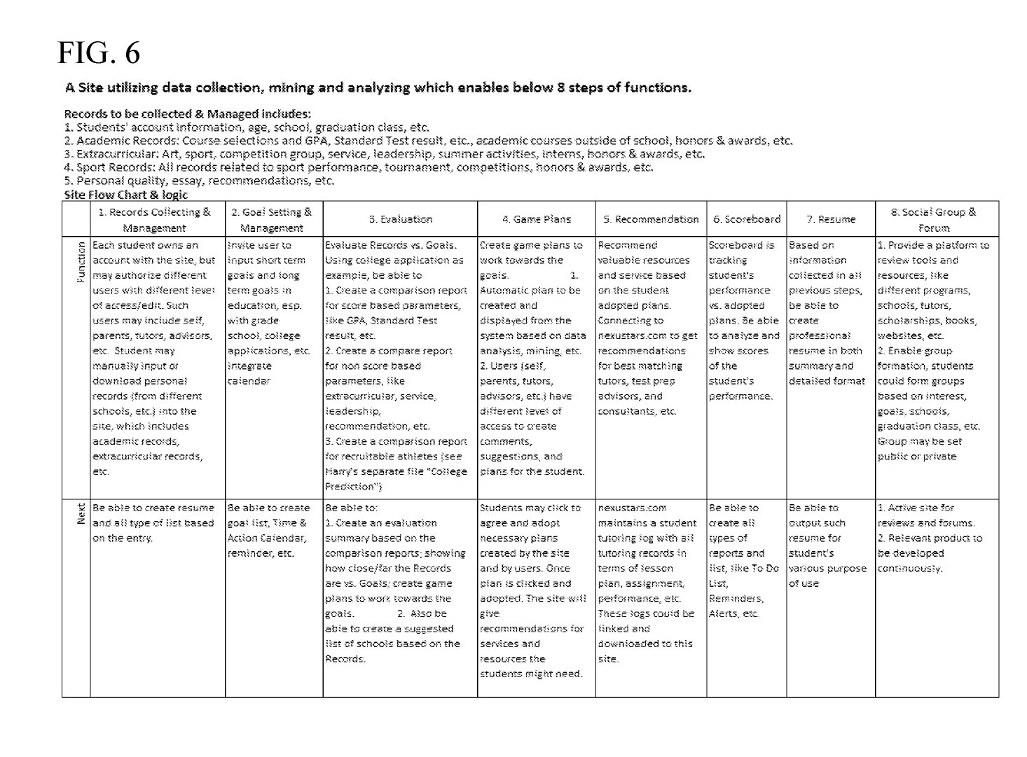

For example, if a student has a long term goal of becoming a Mechanical Engineer, the specialized profile evaluator 250 may evaluate the user's profile information related to his or her GPA and involvement in both Math and Science and compare that information to historic averages for Mechanical Engineers. Additionally, the specialized profile evaluator 250 may also compare the student's progress to other users who have had the same goals. The specialized profile evaluator 250 may compare the student's progress to other users of the same age and/or skill set, or the specialized profile evaluator 250 may compare the student's progress to an average of selected students that have completed or are pursuing the same goa. The specialized profile evaluator 250 may be used to create a comparison report that details how close or how far a user is away from his or her goals. Additionally, the comparison report may show how a user is progressing in relation to other users with the same goals. For example, the specialized profile evaluator 250 may gather benchmarks for the chosen goal and the average time it took other users to reach those benchmarks. Then, the specialized profile evaluator 250 may generate a comparison report to show the user if they are progressing faster than the average, are on track, or are progressing slower than the average user. For example, if the user set a goal to run a 6 minute mile, and they can currently run an 8 minute mile, the specialized profile evaluator may set benchmarks of a 7.5 minute mile, a 7 minute mile, and a 6.5 minute mile and gather data from other users who started at the same 8 minute mile pace to determine how many days of training it took them to reach mile times of 7.5 minutes, 7 minutes, and 6.5 minutes. When the user reached each of those milestones, the specialized profile evaluator 250 could compare the time it took the user to complete the milestone with the average of other users. Additional examples are illustrated in FIG. 6.

In an example embodiment, the profile manager and planner 240 may also include a specialized game plan generator 252, which may be used to generate a game plan for the user based on the comparison report created by the specialized profile evaluator 250. The game plan generator 252 creates a game plan from analyzing large sources of data and performing data mining operations. For example, if the user has a goal of being drafted by a professional sports team as a wide receiver, the game plan generator 252 may gather information about which colleges tend to send the most wide-receivers to the NFL and may also determine the average or distribution of data related to the height and weight of newly drafted wide receivers. Then, the specialized game plan generator 252 may develop a strategy into getting into the proper college and provide a workout program so that the user can achieve the desired weight.

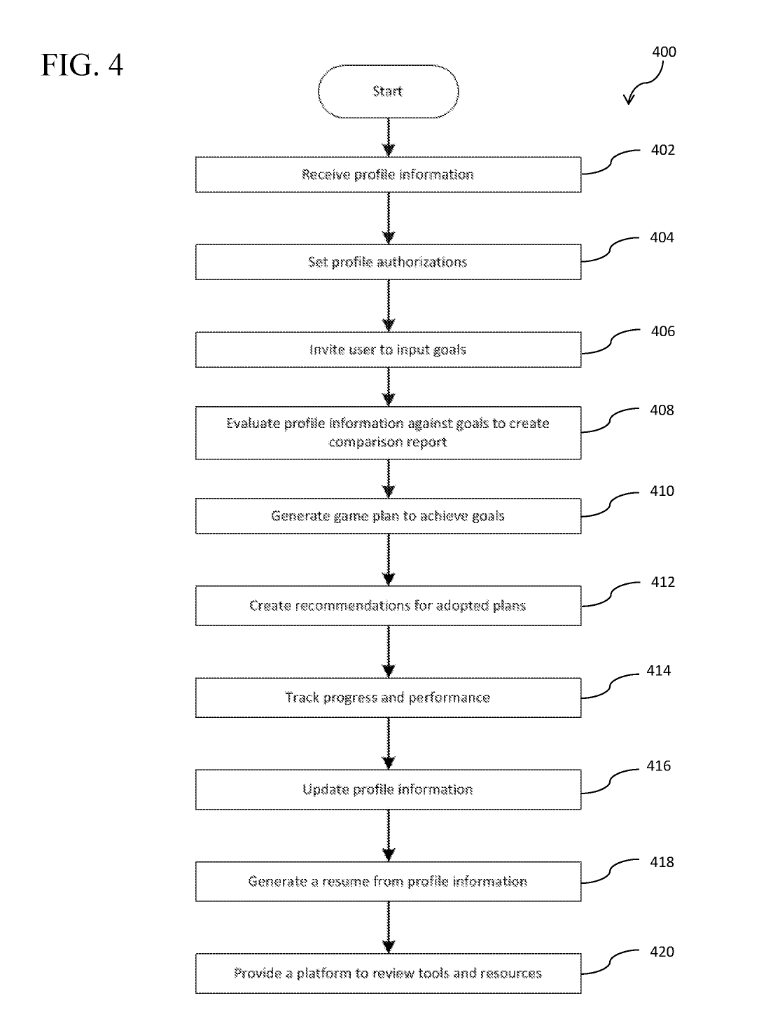

In an example embodiment, a printer and/or other output devices may also be connected to the main unit 242. For example, the printers may be used to print resumes, progress reports, and/or profile information (described in more detail below in relation to FIG. 4).

FIG. 4 is a flow diagram showing example procedure 400 to manage student profiles, track progress, and generate recommendations and resume reports, according to an example embodiment of the present disclosure. Although the procedure 400 is described with reference to the flow diagram illustrated in FIG. 4, it will be appreciated that many other methods of performing the acts associated with the procedure 400 may be used. For example, the order of many of the blocks may be changed, certain blocks may be combined with other blocks, and many of the blocks described are optional.

The example procedure 400 operates on, for example, the user device 102 of FIG. 1. The procedure 400 begins when the user device 102 receives profile information from a user (e.g., student) (block 402). The profile information may be input through a website interface and may include the user's name, age, school, graduation class, etc. An example of the website logic and flow chart is shown in FIG. 6. Additionally, the profile may include academic records such as course selections and GPA, standardized test results, honors and awards, etc. The profile information may also include extracurricular and leadership involvement, and sport achievements and records. The user may also include information about character and any personal qualities, work and/or writing samples, and recommendation letters on their profile. The profile information may be manually inputted by the user using the user device 102, or the user may upload records and documents into the profile. The user may also set profile authorizations to allow other users to access and/or edit the profile (block 404). For example, a student user may authorize his parents the ability to edit his profile so that they can upload relevant documents into the profile.

Once the profile is created, the system invites the user to input goals (block 406). The user may input both short term and long-term goals related to profile information (e.g., education, extracurricular activities, etc.). In an example embodiment, the system includes an integrated calendar to specify target dates to achieve the short term and long-term goals. Then, the system evaluates the user's profile information against the established goals to create a comparison report (block 408). For example, the system may generate a comparison report for score based parameters such as GPA and standardized test results. Additionally, the system may create a report for extracurricular activities, leadership, and service. In an example embodiment, the system may generate a comparison report for academic achievements to show how far the user is from his/her goal of being an attractive candidate for sport recruitment and scholarships. Then, the system generates a game plan for achieving the goals created by the user (block 410). The system analyzes the profile information, goals, and performs data mining to generate a game plan to achieve the goals. Once the game plan is adopted, the system creates recommendations for the adopted plans (block 412). For example, if the user's goals are to improve his ACT math score, the system may suggest a list of local math tutors (see FIGS. 3A and 3B), may provide links to purchase ACT math prep books, or may provide other detailed plans such as a study schedule.

After a user starts participating in an adopted game plan, the system tracks the user's performance within the adopted game plan (block 414). In an example embodiment, the system is able to create progress reports, “To Do” lists, reminders, alerts, etc. when tracking the user's progress to help the user stay on task and achieve his or her goals. Once a goal is achieved or new tasks are completed, the system may automatically update the user's profile information to reflect the achievements (block 416).

After the profile information is updated and/or after the profile information is initially completed, the system can generate a professional resume (block 418). The resume can be selected from various formats and versions to highlight specific areas of achievement and/or to meet specific length requirements. The resume can also be stored in the user's profile to be used and/or accessed for various purposes such as school or job applications. During the process 400, the system provides a platform to review tools and resources (block 420). For example, the system may enable group formations so that students can connect based on interest, goals, schools, graduation class, etc. and may allow additional users to provide input on the user's goals and game plan.

### College Athlete Readiness Predictor

A detailed block diagram of an example college athlete readiness predictor 280 is illustrated in FIG. 2C. In this example, the college athlete readiness predictor 280 includes a main unit 282, which preferably includes at least one data processors 284 and an interface 286. The data processors 284 may be any suitable processor and may be communicatively coupled by an address/data bus to at least one memory device 288. The memory 248 preferably includes volatile memory and non-volatile memory. Preferably, the memory 248 stores a software program that interacts with the other devices in the system 100, as described below. This program may be executed by the data processor 284 in any suitable manner. The memory 288 may also store digital data indicative of documents, files, programs, web pages, etc. retrieved from the college athlete readiness predictor 280.

In an example embodiment, the college athlete readiness predictor 280 may also include a specialized predictor 290, which may utilize information and ranking data to predict where the student will be when they are ready to apply for college. For example, the specialized predictor 290 may use a first year high school student's profile information to make a projection of where the student will be in relation to grades and sport achievements by the time they are a senior in high school. This projection can then be used to determine if the student is on the right path to being college ready. In an example embodiment, the specialized predictor 290 automatically updates the projection in real time based on updates to the user's profile information and changes in the user's age.

The college athlete readiness predictor 280 may also include a specialized plot renderer 292, which is used to display a College Direction Coordinate graph (or college prediction graph). The College Direction Coordinate graph includes academic achievements plotted along the X-axis and athletic achievements plotted along the Y-axis. All College-sport combinations lie on a quarter circle on the graph and different college-sport combinations results in a different direction in the College Direction Coordinates. For example, a student with a grade school academic GPA and grade school athletic ranking will result in a first point plotted on the graph. In another example embodiment, the first point plotted on the graph may be the student's first year of high school rankings. The students first set of data (for the first point plotted) may be used to make predictions with fellow student athletes in the same year of school as the student. From the first set of data, the college athlete readiness predictor 280 may make a projection of where the student will be in terms of academic and athletic rating at different stages of their high school career, or upon completion of high school. Additionally, a student with a high school GPA and a ranking among all high school athletes will result in a second point plotted on the graph. In another example embodiment, the second data point may be created during the student's second year of high school and a third data point may be made at the conclusion of the student's senior year. Once the final set of data related to the students academic and athletic rating is obtained, the college athlete readiness predictor 280 may rank the student to the entire class population. Then, college athlete readiness is calculated from a normalization of GPA in relation to athletic achievements by a factor N. The factor N may be different depending on the sport selection. If the normalization results in a data point outside of the college-sport quarter circle and in the same direction of his or her dream school, then the user is likely to be college ready.

Data may be collected for each school so that each college-sport combination of sports and academics results in a point on the circle. When the student's normalized athletic and academic rankings are plotted on the graph, the student can see if he or she needs to adjust his or her focus on athletics or academics. For example, if the student's normalized rankings result in plotted points, projections, or directions that result in the student not approaching his or her dream school, then the user can determine if they need to increase their athletic ranking or academic ranking.

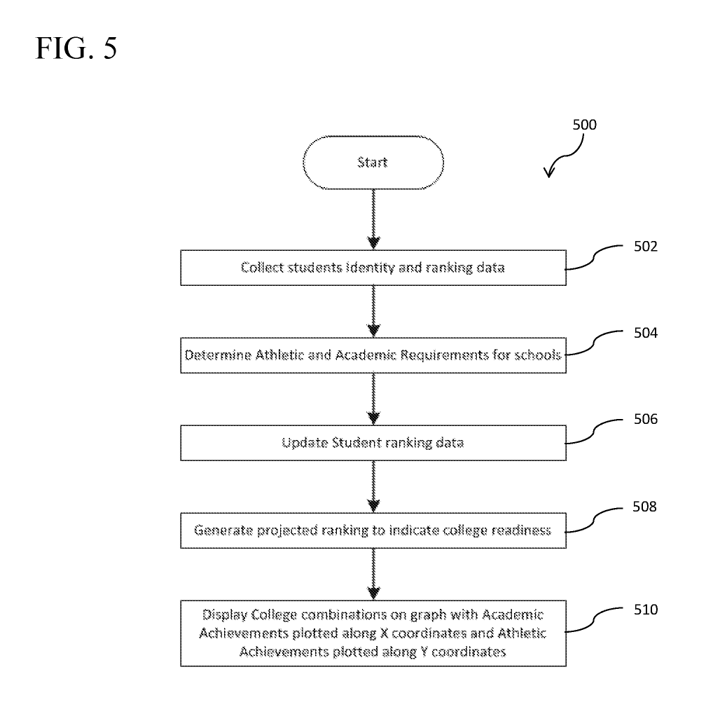

FIG. 5 is a flow diagram showing example procedure 500 to predict college readiness of a user, according to an example embodiment of the present disclosure. Although the procedure 500 is described with reference to the flow diagram illustrated in FIG. 5, it will be appreciated that many other methods of performing the acts associated with the procedure 500 may be used. For example, the order of many of the blocks may be changed, certain blocks may be combined with other blocks, and many of the blocks described are optional.

The example procedure 500 operates on, for example, the network communication device 100 of FIG. 1. First, student identity and ranking data is collected (block 502). In an example embodiment, the identity and ranking data may be obtained from a user profile discussed above in FIG. 4. The ranking data includes both academic and athletic data such as GPA, sports involvement, and sport rankings. The identity data includes first and last name, date, and graduation year. Then, athletic and academic requirements for schools are determined (block 504). The school requirements are determined using statistical methods and Big Data for all the relevant college-sport combinations with the most recent data given the heaviest weight. Then, the user may update his or her ranking data by inputting the most current academic and athletic data (block 506). In an example embodiment, the user's ranking data may be automatically updated if it is linked to the user's profile (see FIG. 4). Next, the system generates a projected ranking to indicate college readiness (block 508). For example, the system may project where the user may end up at the end of high school based on their current rankings and year in school. Once the student is ready to apply to schools, the system displays college-sport combinations on a college prediction graph (block 510). The college prediction graph is displayed in college direction coordinates. The college direction coordinates includes academic achievements plotted along the X coordinate and athletic achievements plotted along the Y coordinate. All of the colleges lie on a quarter circle and different college-sport combinations result in a different direction in the college direction coordinates. For example, a user with grade school academic and athletic ranking will be a point as a projection of his college direction. When the user's ranking data is updated with his high school academic and athletic ranking data, will provide another point in the college direction coordinate. A point outside of the college-sport quarter circle and in the same direction of his or her dream school is likely to be college ready.

### CONCLUSION

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method to manage profiles and perform translations comprising:
receiving, a registration request from a user device operated by a user;
providing, via an application server, a registration interface to the user device for display to the user;
receiving at least one expertise area selection and a user identifier in a base language from the user device;
converting the at least one expertise area selection from the base language to a target language from a translation database;
sorting the users by expertise area selection and credentials into a list; and
transmitting, for display on the user device, the list of users in the target language to a target user on the user device.

2. The method of claim 1, further comprising generating an expertise area selection by:
receiving, via the interface on the user device, text from the user in the base language;
generating a translation in the target language; and
entering the translation as the at least one expertise area selection.

3. The method of claim 1, further comprising generating an expertise area selection by:
receiving, via the interface on the user device, a sentence string from the tutor user in the base language;
accessing a translation system;
generating a plurality of translations of the sentence string in the target language;
comparing the plurality of translations in the target language to confirm a satisfactory translation; and
saving the satisfactory translation to the translation database.

4. The method of claim 3, further comprising: adjusting the translation for unsatisfactory translations.

5. A method of validating translation information comprising:
receiving, via an interface on a user device, at least one sentence string from a user in a base language;
accessing a translation system;
generating a plurality of translations of the at least one sentence string in a target language;
comparing the plurality of translations in the target language to confirm a satisfactory translation; and
returning the satisfactory translation to the user.

6. The method of claim 5, further comprising: saving the satisfactory translation to a translation database.

7. The method of claim 5, further comprising: adjusting the translation for unsatisfactory translations.

8. A method to manage student profiles comprising:
receiving profile information from a user device operated by a user;
inviting, via an interface on the user device, the user to input at least one goal;
evaluating profile information and the at least one goal to create a comparison report in response to the profile information and the at least one goal;
generating a game plan to achieve the at least one goal; and
creating at least one recommendation in response to the game plan.

9. The method of claim 8, further comprising:
tracking the user's progress in relation to the at least one goal and the game plan;
updating the profile information in response to the user's progress; and
generating a report in response to the user's progress.

10. A method to predict college readiness comprising:
collecting student identity data and a first ranking data, wherein the ranking data includes athletic data and academic data;
determining an athletic requirement and an academic requirement from a plurality of schools;
collecting at least one updated ranking data; and
plotting the first ranking data and the at least one updated ranking data on a college-sport combinations graph, wherein the college-sport combinations graph includes academic data plotted along an X coordinate and athletic data plotted along a Y coordinate.

11. A profile management system comprising:
a network interface;
a user device having a processor; and
a memory coupled to the processor, wherein the memory comprises instructions for execution on the processor configured for executing steps of:
receiving a registration request from a user device operated by a user;
providing, via an application server, a registration interface to the user device for display to the user;
receiving at least one expertise area selection and a user identifier in a base language from the user device;
converting the at least one expertise area selection from the base language to a target language from a translation database;
sorting the users by expertise area selection and credentials into a list; and
transmitting, for display on the user device, the list of users in the target language to a target user on the user device.
